(19) United States
(12) Patent Application Publication
(10) Pub. No.: US 2004/0081539 A1
(43) Pub. Date: Apr. 29, 2004

(54) Three and one-half inch form factor tape cartridge autoloader

(76) Inventor: Steven J. Berens, Boulder, CO (US)

Correspondence Address: PATTON BOGGS, PO BOX 270930, LOUISVILLE, CO, 80027, US

(21) Appl. No.: 10/279,467

(22) Filed: Oct. 24, 2002

(51) Int. Cl. B65G 1/00

(52) U.S. Cl. 414/267

(57) ABSTRACT

The tape cartridge autoloader comprises a tape drive and up to fifteen respective tape cartridge storage positions for tape cartridges all located within a three and one-half inch form factor. The tape cartridge storage assembly includes a plurality of tape cartridge trays that rotate around an oval-shaped track located in the sides of the tape cartridge autoloader for moving the plurality of tape cartridge trays between a first level and a second level. A movable picker located between the plurality of tape cartridge trays and the tape drive transports the tape cartridges between the state cartridge trays and the tape drive.

### FIELD OF THE INVENTION

The present invention relates generally to peripheral memory storage devices for computer systems, and more particularly, to a dual height, two-tape drive multiple magnetic tape cartridge autoloader.

### Problem

It is a problem in the field of magnetic tape cartridge autoloaders to increase the magnetic tape storage density while decreasing the equipment storage area required for the magnetic tape cartridge autoloaders. Magnetic tape cartridge autoloaders, also referred to as libraries, are widely accepted because they combine multiple magnetic tape cartridges and a tape drive within a single chassis for higher data storage capacity. Typically, prior art tape cartridge autoloaders have an array of storage positions for tape cartridges, one or more tape drives, and some type of automated changer or cartridge transport for picking or gripping a tape cartridge and moving the tape cartridge between a storage position and the tape drive. The robotic mechanism, often called a “picker” or “gripper”, is typically mounted to the autoloader chassis relative to the tape drive in order to move the tape cartridges between a storage position and the tape drive.

A problem occurs when decreasing the height of the tape cartridge autoloader since operation requires one or more motor mechanisms for moving the tape drive read/write head to read from and write to each of the multiple magnetic tape cartridges. Likewise, one or more motor mechanisms are required to transport the tape cartridges to and from the tape drive. Another problem occurs when increasing the number of magnetic tape cartridges available within the tape cartridge autoloader without increasing the height and the complexity of the tape cartridge autoloader.

Vertically Orientated Tape Cartridge Autoloader

Heinze, et al, (U.S. Pat. No. 6,038,099) discloses a tape cartridge autoloader that includes a drive plate for positioning the tape drive. In Heinze, the tape cartridges are horizontally stacked one above the other in a removable magazine and the read/write head is transported up and down to read/write data from/to the tape media enclosed within the tape cartridges. While the tape cartridge autoloader disclosed in Heinze allows multiple tape cartridges to be accessed by a single read/write head, the number of tape cartridges that the magazine houses is limited by the height of the tape cartridge autoloader. Increasing the number of tape cartridges increases the height of the tape cartridge autoloader. Additionally, valuable space within the chassis is utilized to move the read/write head up and down for reading from or writing to each of the tape cartridges.

A second type of tape cartridge autoloader accommodates multiple tape cartridges and transports the tape cartridge to the stationary tape drive for reading/writing data from/to the tape media enclosed within the tape cartridge. The tape cartridge autoloader disclosed in Schneider, et al., (U.S. Pat. No. 6,229,666) pivots the tape drive about an axis. The multiple tape cartridges are vertically stacked one above the other in a fan orientation wherein the angle of each one of the multiple tape cartridges corresponds to the angle of the pivoting tape drive. In Schneider, the tape drive pivots into alignment for loading and unloading one of the multiple tape cartridges into the tape drive. Like the tape cartridge autoloader disclosed in Heinze, the number of tape cartridges vertically stacked within the magazine is limited by the height of the tape cartridge autoloader in Schneider. As the magazine is expanded to hold a greater number of tape cartridges, the height of the tape cartridge autoloader is increased.

While the tape cartridge autoloaders just described provide an apparatus for reading from and writing to multiple tape cartridges, they fail to provide a tape cartridge autoloader housing an increased number of tape cartridges in a reduced height.

Horizontally Orientated Tape Cartridge Autoloader

A solution to the increased height of the tape cartridge autoloaders having vertically stacked tape cartridge has been to horizontally stack the tape cartridges. Ostwald (U.S. Pat. No. 5,995,320) discloses a tape cartridge autoloader that orients the tape cartridges in a horizontally oriented loading bin, or magazine. The horizontally oriented storage bin stores tape cartridges like books in a bookcase, each tape cartridge standing next to the adjacent tape cartridge. Unlike the vertically oriented tape cartridge autoloaders previously discussed, the Ostwald tape cartridge autoloader occupies a vertical space consistent with the width of the associated tape cartridges. The horizontal orientation enables the horizontally oriented tape cartridge autoloaders to be mounted in a vertical rack, thus increasing the storage capacity without increasing the vertical height.

However, a problem occurs with the horizontally oriented storage bin. While the tape cartridges are each one-half inch in height, storing the tape cartridges side-by-side increase the vertical height of the tape cartridge autoloader to the width of the tape cartridge. While this tape cartridge storage configuration increases the number of tape cartridges that may be stored in a particular vertical height, the vertical height does not conform to the standard form factor.

The use of vertical racks has become popular to reduce the space required for computer equipment servers, data storage devices, and other computer peripheral equipment. The form factor of vertical racks has been standardized to accept an equipment chassis that is approximately 19 inches wide by 28 inches deep. The “form factor” refers generally to the peripheral dimensions of the chassis. The height of the chassis is in multiples of 1.75 inches, referred to in the industry as a “U”. A 1U height chassis refers to a 1.75 inch height chassis while a 2U height refers to a 3.5 inch height and so on. Peripherals and tape cartridges, such as single reel tape drives and single reel magnetic tape cartridges, also have standardized form factors. For example a single reel tape drive may have a half-high form factor. When referring to the form factor of a tape drive peripheral, the single reel tape drive is a half-high (1.5 inch high) form factor. Thus, the height of the tape drive influences the form factor of the chassis for the tape cartridge autoloaders. Installing a half-high form factor tape cartridge into a tape cartridge autoloader leaves 0.25 inch for operational components. 2U rack mount tape cartridge autoloaders that accept one inch tape cartridges are known. The know 2U tape cartridge autoloader is the 640 Blade (Trademark) tape cartridge autoloader of Benchmark Storage Solutions, the assignee of the present invention. The Benchmark 640 Blade comprises up to up to eight horizontal tape cartridges cells that are rotated in a circular motion around a centrally located tape drive. The tape drive is approximately 1.5 inches in height. In the 640 Blade, fans, motors and other structural features are located below the tape drive, thus the combination of the tape drive and components located below the tape drive influence the overall height of the tape cartridge autoloader.

What is needed is a dual height, three and one-half inch tape cartridge autoloader having horizontally oriented tape drive and tape cartridges with the operational components located between the tape cartridges and tape drive.

### Solution

The present three and one-half inch form factor tape cartridge autoloader provides a tape drive and a tape cartridge storage assembly having plurality of tape cartridge storage cells for housing a plurality of tape cartridges. The tape cartridge storage assembly comprises a plurality of adjacent tape cartridge trays that rotate around an oval-shaped track located on the side of the tape cartridge autoloader.

Each tape cartridge tray includes tape cartridge storage cells, each housing an individual tape cartridge. The tape cartridge storage trays individually interconnect with the U-shaped track such that a subset of the plurality of tape cartridge trays are located on a upper level and the remaining tape cartridge trays are located on a lower level. As one of the plurality of tape cartridge trays travel along one of the arcuate areas of the oval-shaped track, one of the plurality of tape cartridge trays moves from an upper level to a lower level and a corresponding one of the plurality of tape cartridge trays following the opposite arcuate area of the oval-shaped track moves from the lower level to the upper level.

Operational components for moving the tape cartridge storage trays around the oval-shaped track include a tape cartridge drive assembly for rotating the tape cartridge trays following the oval-shaped track. A picker located between tape cartridge storage assembly transports a predetermined tape cartridge between the tape cartridge tray and a tape drive.

### BRIEF DESCRIPTION OF THE DRAWINGS

FIG. 1 illustrates a perspective view of the present three and one-half inch form factor tape cartridge autoloader;

FIG. 2 illustrates a top view, in block diagram form, of the present three and one-half inch form factor tape cartridge autoloader illustrating the upper level of tape cartridges;

FIG. 3 illustrates another top view of the present three and one-half inch form factor tape cartridge autoloader illustrating the lower level of tape cartridges;

FIGS. 4a-4b illustrate a side view of the tape cartridge movement within the present three and one-half inch form factor tape cartridge autoloader;

FIG. 5 is a flow diagram of the tape cartridge storage assembly operation; and

FIG. 6 is a flow diagram of the operation of the present three and one-half inch form factor tape cartridge autoloader.

### DETAILED DESCRIPTION

The rack mount tape cartridge autoloader summarized above and defined by the enumerated claims may be better understood by referring to the following detailed description, which should be read in conjunction with the accompanying drawings. This detailed description of the preferred embodiment is not intended to limit the enumerated claims, but to serve as a particular example thereof. In addition, the phraseology and terminology employed herein is for the purpose of description, and not of limitation.

Magnetic tape cartridge autoloaders, also referred to as libraries, are widely accepted because they combine multiple magnetic tape cartridges and a tape drive within a chassis for higher data storage capacity. With the significant growth in disk capacity on even entry level servers used in a Local Area Network and with the increasing amount of mission critical data being stored on these servers, there is a need for tape cartridge automation in the low-end server environment. Organizations seek autoloader solutions that can address the need for a full week's backup of server data, requiring five or more tape cartridges. A one-drive autoloader meets the majority of the needs in this environment.

The form factor of vertical racks has been standardized to accept an equipment chassis that is approximately 18 inches wide by 28 inches deep. The “form factor” refers generally to the peripheral dimensions of the chassis. The height of the chassis is in multiples of 1.75 inches, referred to in the industry as a “U”. A 1U height chassis refers to a 1.75 inch height chassis while a 2U height refers to a 3.5 inch height and so on. Peripherals and magnetic tape cartridges, such as single reel magnetic tape cartridges and single reel tape drives, also have a standardized form factor. For example a single reel tape drive may have a half-high form factor. When referring to the form factor of a tape drive peripheral, the single reel tape drive has a half-high (1.5 inch high) form factor while the height of the single reel tape cartridge is a one-inch. Thus, the height of the tape drive and the tape cartridges influences the form factor of the chassis for the tape cartridge autoloaders.

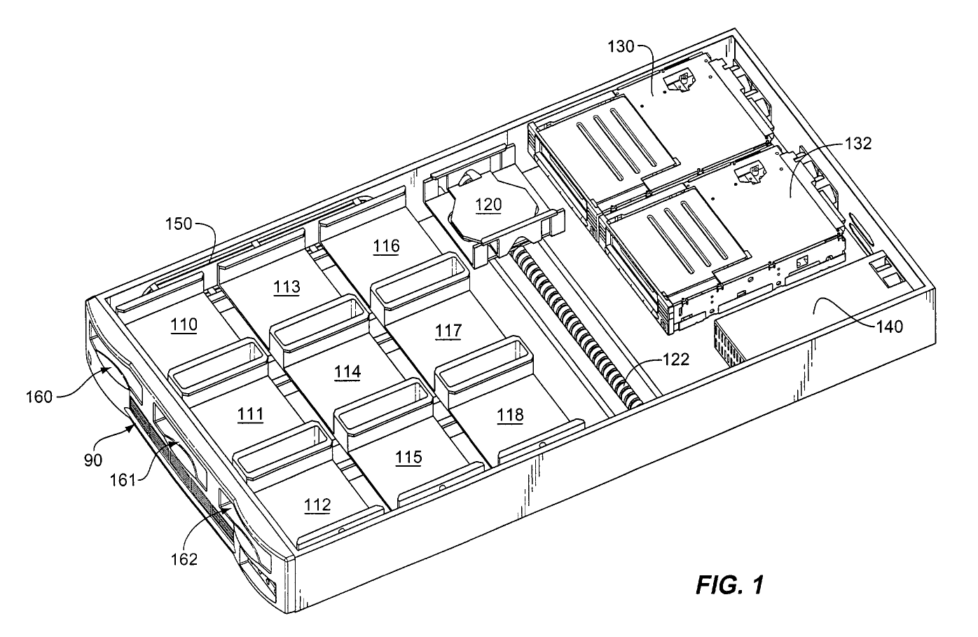

Referring to FIG. 1, the present tape cartridge autoloader 100 comprises two tape drives 130 and 132, a tape cartridge storage assembly including tape cartridge storage cells 110-118 and 210-215 for storage of up to fifteen tape cartridges, and picker 120 for transporting tape cartridges between the tape drives and the storage cells all located within a 2U form factor height of three and one-half inches. The picker 120 for transporting one of the tape cartridges to the tape drive 130 or 132 is located between the tape cartridge storage assembly and the tape drives 130 and 132 and is driven by picker drive mechanism 122. The tape drives 130 and 132 are located on one side of the picker 120 at the rear of the tape cartridge autoloader 100 and the tape drive tape cartridge aperture (not shown) faces the picker 120 for inserting and extracting the tape cartridges, one at a time. Tape cartridge apertures 160-162 in the front panel 90 of the tape cartridge autoloader provides the access required for sliding the tape cartridges into and out of the tape cartridge autoloader 100.

The tape cartridge autoloader 100 may also include a power source 140 for supplying power to the tape drives 130 and 132, the picker motors (not shown) and other operational components not illustrated, and a control circuit having a processor and memory for executing an operational program for operating the tape cartridge autoloader in accordance with the following description. A control panel (not shown) on the front panel allows the user to control the operation of the tape cartridge autoloader. The control panel may include such operational controls as an open/close button for inserting and ejecting tape cartridges and a display to provide information to the user.

While the present three and one-half inch form factor tape cartridge autoloader is described having three tape cartridge apertures for inserting/extracting tape cartridges into and out of the three and one-half inch form factor tape cartridge autoloader, a removable magazine holding more than one tape cartridge may be substituted. Likewise, an alternative number of tape cartridge apertures may be located on the front panel for loading/unloading of a tape cartridge.

The three and one-half inch form factor tape cartridge autoloader may be mounted in a standard computer equipment rack with the front plate, and therefore the tape cartridge aperture or removable magazine and control panel, readily accessible to the user. Providing tape cartridge apertures on the front panel of the tape cartridge autoloader allows the user to insert or extract individual tape cartridges, unlike prior art tape cartridge autoloaders that require the user to remove a magazine of tape cartridges when a single tape cartridge requires replacement. The front plate of the tape cartridge autoloader may include a control panel to allow the user to select operational characteristics such as loading or unloading a tape cartridge. When tape cartridges are inserted into the tape cartridge autoloader, the tape cartridges are stored in storage cells and the control circuit processor records the tape cartridges and the storage cell in which the tape cartridge is located.

The tape cartridge storages cells are aligned in adjacent tape cartridge trays which interconnect with an oval-shaped track located on the sides of the tape cartridge autoloader. The configuration of the tape cartridge trays for movement around the oval-shaped track decreases the height of the tape cartridge autoloader and provides capacity for additional tape cartridges within the present three and one-half inch form factor tape cartridge autoloader.

Tape Cartridge Storage Configuration 1, 2 and 3:

The tape cartridge storage cells 110-118 and 210-215 provide storage locations for up to fifteen tape cartridges 110-118 and 210-215. Each tape cartridge storage cell comprises a base and two sides extending upward from the base for horizontally holding a tape cartridge. The sides of the tape cartridge storage cell are approximately the height of the tape cartridge such that the height of the tape cartridge autoloader is not unduly influenced by the height of the tape cartridge storage cells. The height of the tape cartridge is approximately one inch, thus the overall height of the tape cartridge storage cell is slightly more than one inch. Two layers of tape cartridge storage cells is slightly more than two inches. Added space above, below and between each layer to allow the tape cartridge trays to move following the oval-shaped track. The two layers of tape cartridges fits within the 3.5 inch height of the 2U form factor.

Tape cartridge apertures 160-163 in the front panel 90 of the tape cartridge autoloader 100 allows the user to insert/extract tape cartridges into/out of the tape cartridge autoloader 100, one at a time. After tape cartridges are loaded into the tape cartridge tray storage cells located adjacent to the tape cartridge apertures, the tape cartridge tray is moved away from the tape cartridge apertures, toward the tape drive(s) and another tape cartridge tray rotates from the lower level to the upper level aligned adjacent to tape cartridge apertures. While FIG. 1 illustrates three tape cartridge apertures 160-162 in the front panel 90 adjacent to the upper level of tape cartridges, the tape cartridge autoloader 100 may be configured to have tape cartridge apertures on the lower level or a combination of upper and lower tape cartridge apertures.

In this configuration, one tray of tape cartridge storage cells is adjacent to picker 120 and another one of the tape cartridge trays on the upper level is adjacent to the tape cartridge apertures 160-162 in the front panel. Thus, the horizontal area within the tape cartridge autoloader is utilized to maximize the number of tape cartridge storage cells that are available for tape cartridges without increasing the height of the tape cartridge autoloader. This configuration also decreases the complexity of the operational components required to access and transport tape cartridges from the tape cartridge storage cells to the tape drive(s).

Tape Cartridge Movement—FIGS. 1-4:

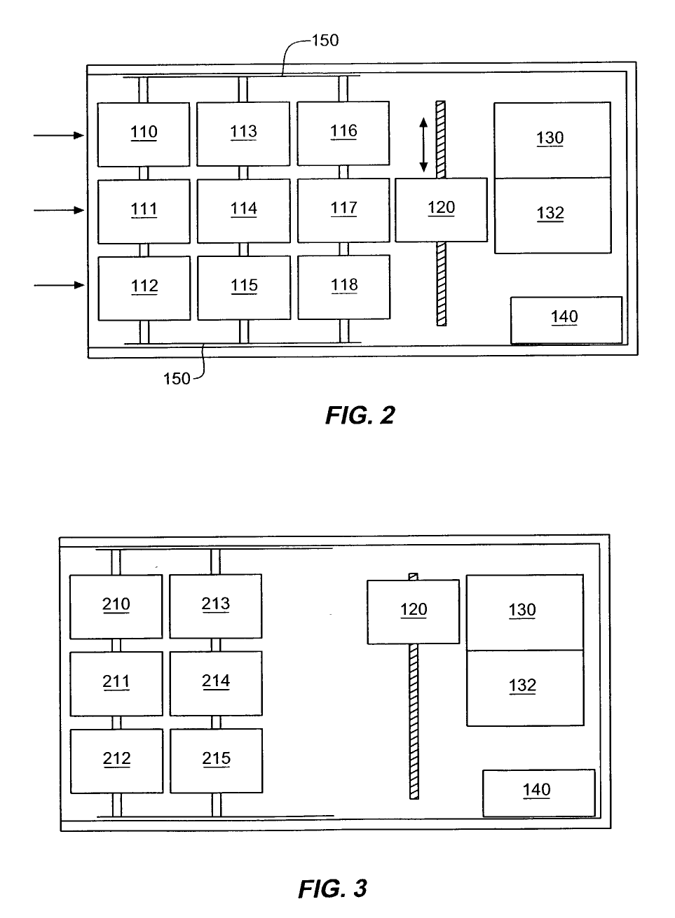

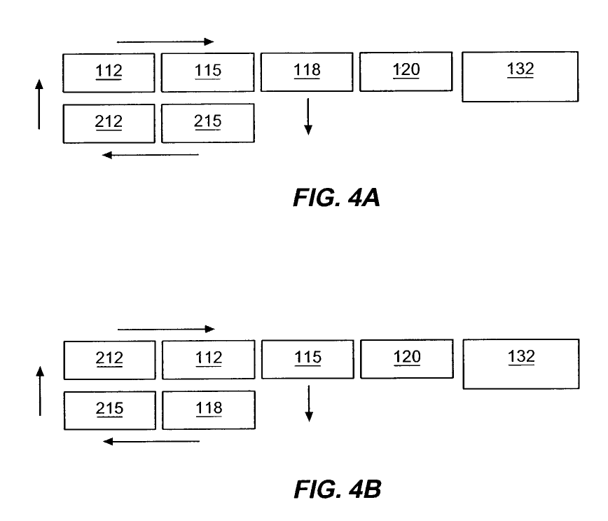

Referring to FIGS. 2 and 3, tape cartridge storage cells are rotated following the oval shaped track 150 until the tape cartridge tray housing the predetermined tape cartridge is adjacent to picker 120. Three tape cartridge trays are located on an upper level (FIG. 2) while two tape cartridge trays are located on the lower level (FIG. 3). In the example illustrated in FIG. 4, the two levels of tape cartridge trays house tape cartridges 112, 115 and 118 on one side of the upper level and tape cartridges 212 and 215 on the same side of the lower level. As the upper level trays of tape cartridge assembly travel toward the rear of the tape cartridge autoloader, the lower level trays of tape cartridge storage cells travels forward toward the front of the tape cartridge autoloader as indicated by the arrows above and below the tape cartridge assembly.

An elongated member is connected to the base of each tape cartridge tray. The ends of the elongated member interconnects with the oval shaped track on the side of the tape cartridge autoloader interior surface for moving the tape cartridge tray following the oval-shaped track. The elongated member is located to maintain the tape cartridge tray in a horizontal position as the tape cartridge tray travels following an arcuate area of the oval-shaped track. This configuration prevents a tape cartridge housed within the tape cartridge tray from sliding our of the tape cartridge tray.

Following the oval-shaped track (not shown) on the side of the tape cartridge autoloader, the tape cartridge trays rotate clockwise as shown by the arrows. As the tape cartridge storage tray adjacent to picker 120 follows the arcuate area of the oval-shaped track, tape cartridge 118 transitions from the upper level to the lower level as illustrated by the before and after side views of FIGS. 4a and 4b. Likewise, as the tape cartridge tray containing tape cartridge 212 rotates following the opposite arcuate area of the oval track, tape cartridge 212 transitions from the lower level to the upper level. The intermediary tape cartridge trays following the oval-shaped track rotate into new positions wherein tape cartridge 115 moves from a center position on the upper level to a position adjacent to picker 120.

Movement of tape cartridges between the tape cartridge storage cell and the tape drive is accomplished by a picker 120 comprising a transport storage cell for housing the tape cartridge during transport and a picker drive assembly (not shown) for moving the picker 120 between the adjacent tape cartridge tray and tape drives 130 and 132. The picker my be one of a variety of conventional designs for extracting a tape cartridge from a tape cartridge storage cell, transporting the tape cartridge to the tape drive, and inserting the tape cartridge into the tape drive and vice-versa. The transport storage cell illustrated as a part of the picker in FIG. 1 has a front side open for accepting the tape cartridge and the opposite back side open for inserting/extracting the tape cartridge within the picker into/out of the tape drive. While the transport storage cell is illustrated and described with an open top portion, an alternative configuration may be utilized such as a transport storage cell closed at the top.

Picker 120 travels along the adjacent tape cartridge tray to a predetermined location such as adjacent to tape cartridge 116. Once aligned, tape cartridge 116 is extracted from the tape cartridge storage cell, transported to a predetermined one of the tape drives 130 and 132 and inserted into the predetermined tape drive.

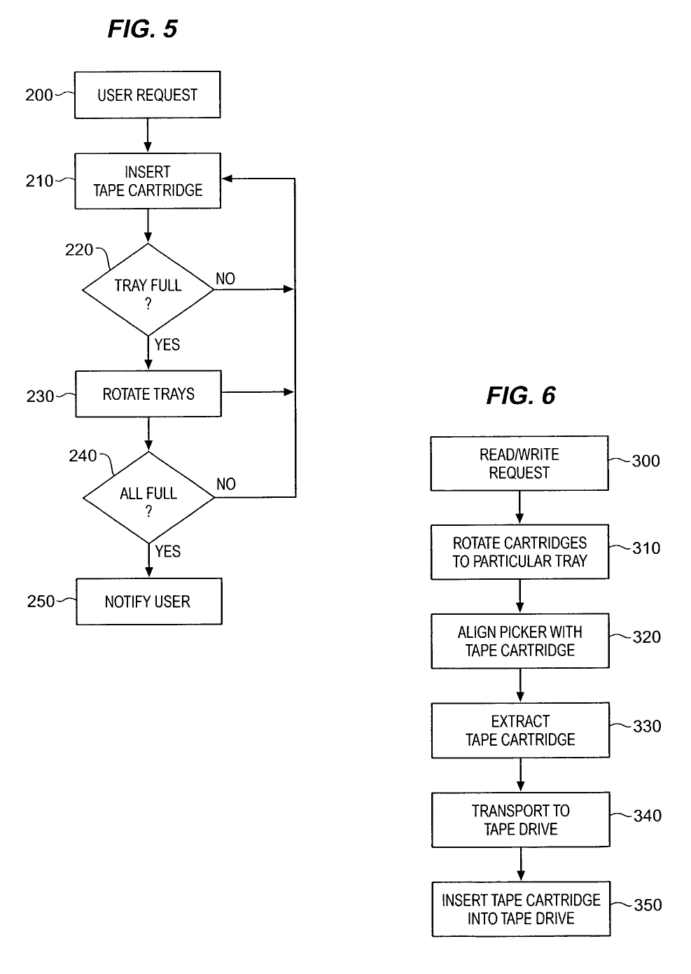

Autoloader Operational Characteristics—FIGS. 5 and 6:

Referring to the tape cartridge storage assembly operational flow diagram of FIG. 5, the control circuit rotates the trays of tape cartridges to a predetermined tray in response to a user request for insertion/extraction of a particular tape cartridge in step 200. In step 210 the user may insert a tape cartridge into an empty tape cartridge storage cell via the tape cartridge aperture in the front panel of the tape cartridge autoloader. If another tape cartridge is to be inserted in step 210, the control circuit checks to see if the tape cartridge tray is full in step 220. If the tape cartridge tray is not full in step 220 another tape cartridge is inserted in step 210. If the tape cartridge storage tray is full in step 220, the control circuit rotates the tape cartridge trays until a tape cartridge tray having an empty storage cell is aligned with the tape cartridge apertures. When all of the tape cartridge storage cells contain a tape cartridge in step 240, the control circuit notifies the user in step 250 that the tape cartridge autoloader is full.

In response to a read/write request in step 300 of the operational flow diagram of FIG. 6, in step 310 the control circuit rotates the tape cartridge trays to a predetermined tray containing the particular tape cartridge. When the tape cartridge tray containing the particular tape cartridge is adjacent to the picker, the picker is aligned in step 320 with the tape cartridge storage cell containing the particular tape cartridge. The tape cartridge is extracted from the tape cartridge storage cell in step 330 and transported in step 340 to a tape drive where in step 350 the tape cartridge is inserted into the tape drive. Similarly, a request to extract the tape cartridge from the tape drive or to replace the tape cartridge within the tape drive with another tape cartridge, the picker is aligned with the tape drive to remove the tape cartridge and transport the tape cartridge to an empty tape cartridge storage cell.

Operationally, two drive assemblies are required to operate the present one and three quarter form factor tape cartridge autoloader. The tape cartridge trays are rotated following the oval shaped track requiring a storage tray drive assembly for rotating the tape cartridge trays. A second drive assembly, a picker drive assembly, aligns the picker with the tape cartridges and the tape drive. Reducing the complexity of the present three and one-half inch form factor tape cartridge autoloader translates to fewer operational components and reduces the height of the tape cartridge autoloader to conform to a standard 2U form factor. Reducing the number of motors and thus moving components also improves the reliability of the present one and three quarter form factor tape cartridge autoloader. Configuring the tape cartridge storage cells into individual trays that rotate around an oval-shaped track between an upper level and a lower level allows the maximum number of tape cartridges to be stored in a minimum space.

While the present three and one-half inch form factor tape cartridge autoloader has been illustrated and described having two tape drives, an alternative configuration may be substituted. Likewise, the tape cartridge storage assembly may be reconfigured to store an alternate number of tape cartridge storage cells.

Alternative embodiments will occur to those skilled in the art. Although the three and one-half inch form factor tape cartridge autoloader has been described for use with one-inch tape cartridges, alternative tape cartridges could be substituted. Similarly, although embodiments were described and illustrated with two tape drives, an alternative number of tape drives may be substituted. Such variations and alternatives are contemplated, and can be made without departing from the spirit and scope of the invention claimed in the appended claims.

It is apparent that there has been described, a three and one-half inch form factor tape cartridge autoloader that fully satisfies the objects, aims, and advantages set forth above. While the three and one-half inch form factor tape cartridge autoloader has been described in conjunction with specific embodiments thereof, it is evident that many alternatives, modifications, and/or variations can be devised by those skilled in the art in light of the foregoing description. Accordingly, this description is intended to embrace all such alternatives, modifications and variations as fall within the spirit and scope of the appended claims.

What is claimed is:

1. A tape cartridge autoloader sized to fit within a dual height, three and one-half inch form factor chassis the autoloader comprising:
a tape drive having a tape cartridge aperture for inserting/extracting a plurality of tape cartridges, one at a time;
a means for horizontally storing said plurality of tape cartridges such that a first subset of said plurality of tape cartridges is located on a first level and a second subset of said plurality of tape cartridges is located on a second level and said second level is below said first level,
a means for rotating said plurality of tape cartridges such that said plurality of tape cartridges rotate between said first level and said second level; and
a transport means for transporting said plurality of tape cartridge between said horizontal storage means and said tape drive, one at a time.

2. The tape cartridge autoloader of claim 1 wherein said horizontal storage means comprises:
a plurality of respective spaced positions for storing said plurality of tape cartridges, wherein said plurality of respective spaced positions are horizontally positioned in a plurality of trays, each of said plurality of trays connected to said rotating means for rotating said plurality of trays between said first level and said second level.

3. The tape cartridge autoloader of claim 1 wherein said rotating means rotates said plurality of cartridges such that a portion of said first subset of said plurality of tape cartridges rotates downward to said second level and a portion of said second subset of said plurality of tape cartridges rotates upward to said first level.

4. The tape cartridge autoloader of claim 1 wherein said rotating means comprises:
an oval-shaped track located on a side of said chassis wherein said rotating means rotates said horizontal storage means such that a one of said first subset of said plurality of tape cartridges rotates downward to said second level and a corresponding one of said second subset of said plurality of tape cartridges rotates upward to said first level; and
a drive means interfacing with said oval-shaped track and said horizontal storage means for moving said horizontal storage means along said oval-shaped track.

5. The tape cartridge autoloader of claim 1 further comprising:
a means for inserting/extracting said plurality of tape cartridges to/from said tape cartridge autoloader.

6. The tape cartridge autoloader of claim 1 further comprising:
a means for aligning said transport means with one of said tape drive and said plurality of tape cartridges.

7. A tape cartridge autoloader sized to fit within a dual height, three and one-half inch form factor chassis, the autoloader comprising:
a substantially oval-shaped track on an interior surface of a side of said chassis;
a tape drive having a tape cartridge aperture for inserting/extracting a plurality of tape cartridges, one at a time;
a plurality of trays of respective spaced positions for storing said plurality of tape cartridges, wherein said plurality of trays of respective spaced positions rotate following said substantially oval-shaped track;
a drive assembly interfacing with said substantially oval-shaped track and said plurality of trays of respective spaced positions for moving said plurality of trays of respective spaced positions along said substantially oval-shaped track;
a means for transporting a predetermined one of said plurality of tape cartridges between one of said plurality of trays of respective spaced positions and said tape drive; and
wherein as said transporting means travels along said plurality of trays of respective spaced positions, the transport means is aligned with one of said plurality of spaced positions and said tape drive.

8. The tape cartridge autoloader of claim 7 wherein a first subset of said plurality of trays of respective spaced positions are above a second subset of said plurality of trays of respective spaced positions and as one tray of said first subset rotates downward following a curved portion of said substantially oval-shaped track, a corresponding tray of said second subset rotates upward following an opposite curved portion of said substantially oval-shaped track.

9. The tape cartridge autoloader of claim 7 wherein said transport means is located between said tape drive and said plurality of trays of respective spaced positions and travels along one of said first subset of said plurality of trays of respective spaced positions for transporting one of said plurality of tape cartridges from said first subset of said plurality of trays of respective spaced positions to/from said tape drive.

10. The tape cartridge autoloader of claim 7 further comprising:
a means for positioning said transport means at a predetermined one of said respective spaced positions and said tape drive.

11. The tape cartridge autoloader of claim 7 further comprising:
a means for inserting/extracting said plurality of tape cartridges to/from said tape cartridge autoloader.

12. A method for transporting a plurality of tape cartridges within a tape cartridge autoloader to and from a tape drive, said tape cartridge autoloader including said tape drive, a plurality of trays of respective spaced positions for holding said plurality of tape cartridges, a transport device for transporting said plurality of tape cartridges between said plurality of trays of respective spaced positions and said tape drive, and an oval track along an interior side of said chassis for rotating said plurality of respective spaced positions between an upper level and a lower level, the method comprising the steps of:
rotating said plurality of respective spaced positions along said oval track until a predetermined one of said plurality of trays of respective spaced positions is adjacent to said transport device;
moving a picker along said adjacent tray of said plurality of respective spaces to a corresponding one of said plurality of respective spaced positions containing said predetermined one of said plurality of tape cartridges; and
transporting said predetermined one of said plurality of tape cartridges between said corresponding one of said plurality of spaced positions and said tape drive.
